(19) United States
(12) Patent Application Publication
(10) Pub. No.: US 2014/0193797 A1
(43) Pub. Date: Jul. 10, 2014

(54) Ideaboard

(71) Applicant: Bhushan Lele, Clearwater Beach, FL (US)

(72) Inventor: Bhushan Lele, Clearwater Beach, FL (US)

(21) Appl. No.: 13/736,597

(22) Filed: Jan. 8, 2013

(51) Int. Cl. B43L 1/00

(52) U.S. Cl. CPC B43L 1/00
USPC 434/408

(57) ABSTRACT

The Ideaboard comes in two sizes and is truly portable with multiple whiteboard sheets fitted into a ring binder as opposed to the traditional whiteboard that are like pieces of furniture and can not be moved easily. It provides you multiple surfaces, as against one writing surface on a traditional or wheeled whiteboard. Due to its design the board can be used in different positions, Collaboration Mode (Standing up), Writing mode- (folded over in half) and Carry mode (Closed) so that you can have the Ideaboard with you anywhere you go. Available in two sizes—the Medium, and the Mini, it is your personal workspace.

### BACKGROUND OF THE INVENTION

The Ideaboard was invented while I was a graduate student at University of Michigan. At the time I was a part-time student and also working to start a company. A lot of my work was creative and included many ideas and plans, so I enjoyed brainstorming and planning on whiteboards. However, with my hectic schedule and limited access to meeting rooms, I needed a portable whiteboard so that my work schedule would not be restricted. After doing a Google search I found whiteboards on wheels, which were portable within a room, but not possible to carry around. Then I ran into a few other whiteboard products that were possible to carry, but were not practical for usage as they weren't big enough. I started to think about the design of a book, which has multiple pages, and is socially accepted to carry around with you. Multiple pages would increase the surface area yet keep the piece small enough to carry comfortably. In order to attach the multiple sheets, I thought of a ring binder, where whiteboard sheets could be 3 hole punched just like paper, and would hang on the ring binder. Thinking of a book design, I made some drawings and took it to a local book-binder in Michigan. There, the first prototype of the Ideaboard was made.

### BRIEF SUMMARY OF THE INVENTION

The Ideaboard comes in two sizes and is truly portable with multiple whiteboard sheets that fit into a ring binder placed in a binder style folio that can be easily carried; as opposed to the traditional whiteboard that is one writing space, usually up against the wall, and static, since it cannot be easily moved. The Ideaboard can be used in different positions, Collaboration Mode (Standing up), Writing mode- (folded over) and then in Carry Mode (Closed) which is how you can easily transport it so that you can have the Ideaboard with you anywhere you go. The two sizes are the Medium (20×17×1¾ inches), and the Mini (12.5×10.5×1¾inches) The Ideaboard is your personal portable workspace.

### DETAILED DESCRIPTION OF INVENTION

Making the Invention

The cover of the Ideaboard is akin to the hard cover of a book, or the construction of a padfolio binder (the leather notepad binder or book people carry to meetings). The cover uses PU material, and uses machine stitching to add a decorative accent. Once the cover is made, the ring binder is attached to hold the multiple sheets. The Ideaboard uses a 4 ring-binder, while the Mini-Ideaboard uses a 3-ring binder.

The elastic strap helps keep sheets in place and is secured on the bottom right side of the back cover using snap buttons. A short PU strap closure keeps the front and back covers close together so that it is closed and easy to carry.

The whiteboard sheets, clear dry erase sheets, and clear dry erase pockets are all made from PVC. The whiteboard sheets are PVC, with a dry erase coating and have a thickness of 0.3 mm, the clear PVC dry erase template pockets are 0.5 mm thick, while the clear sheets are 0.2 mm thick. All sheets are die-cut with punched holes to match the ring binder. Each Ideaboard is assembled with multiple whiteboard sheets and clear sheets that are placed in between the whiteboard sheets to prevent smudging and to allow for secondary edits. The larger Ideaboard includes 3 whiteboard sheets and 3 clear sheets, while the smaller Ideaboard (the Mini Ideaboard) includes 5 whiteboard sheets and 5 clear sheets. Both the Ideaboards also include two clear PVC dry erase template pockets.

Using the Invention

The Ideaboard has been designed so it can be used in several positions for different situations. It has more versatility than any whiteboard out there. To start with, the Ideaboard can be carried anywhere, as easily as carrying a book, binder or an artist's portfolio. The Ideaboard can be placed on any table surface in writing position, making it easy to keep at, and work from your work desk. This position occurs when the front cover is opened and folded over the back cover all the way, so that the inside front cover actually rests against the desk surface. This also creates a nice ergonomic writing angle for the user to work with.

The Ideaboard can also be propped up in a standing position without needing an easel. This position can occur from closed or writing position as described above. To get the board to stand up, the front cover must flip over the back cover, forming a tent or an isosceles triangle shape with the desk surface (front and back cover are the two same length sides). To lock the board in this position, the elastic strap which originates from the bottom right side of the back cover is secured onto the button located on the center of the front cover, preventing the cover “legs” from shifting. Once in this standup position, the board's multiple whiteboard sheets can be used as a tabletop flip chart, to collaborate with a colleague or to present work. The whiteboard sheets can also be taken out of the board by opening the ring binder, and be adhered to the wall with tape, or Velcro, as well as be pinned to a corkboard or cubicle wall using push pins or similar. This functionality makes it possible to use the Ideaboard also as a more traditional wall whiteboard.

The clear dry erase sheets serve two functions. First, they prevent excessive smudging from occurring when the whiteboard sheets rub against one another, a natural occurrence due to the fact that the sheets sit on top of one another. Second, their dry erase property allows the user to write and make secondary edits on top of the whiteboard sheets.

The Ideaboard also comes with clear dry erase pockets. They serve both the functions that the clear sheets do, but since they have a pocket, you can also put a template in it. This makes it possible to personalize the Ideaboard according to your work and reuse any printed template by making edits on the clear dry erase pocket it rests in.

### BRIEF DESCRIPTION OF THE SEVERAL VIEWS OF THE DRAWING

The drawings show the board lying flat and open and points out to our different claims. It also shows the board in the three different positions as used. These three modes are the Collaboration mode, Writing mode, and Carry mode. Please note that there are 2 different sizes being made of this item. They both have the same design. The Ideaboard in the drawings is the “Medium”, we also carry the “Mini” as mentioned in the respective drawings. The Mini Ideaboard is 12.5×10.5×1¾ inches and comes with 3 rings instead of 4, and no handle due to its compact size. Drawings also include the diagrams and measurements of the PVC sheets for each size Ideaboard.

### DETAILED DESCRIPTION OF THE INVENTION

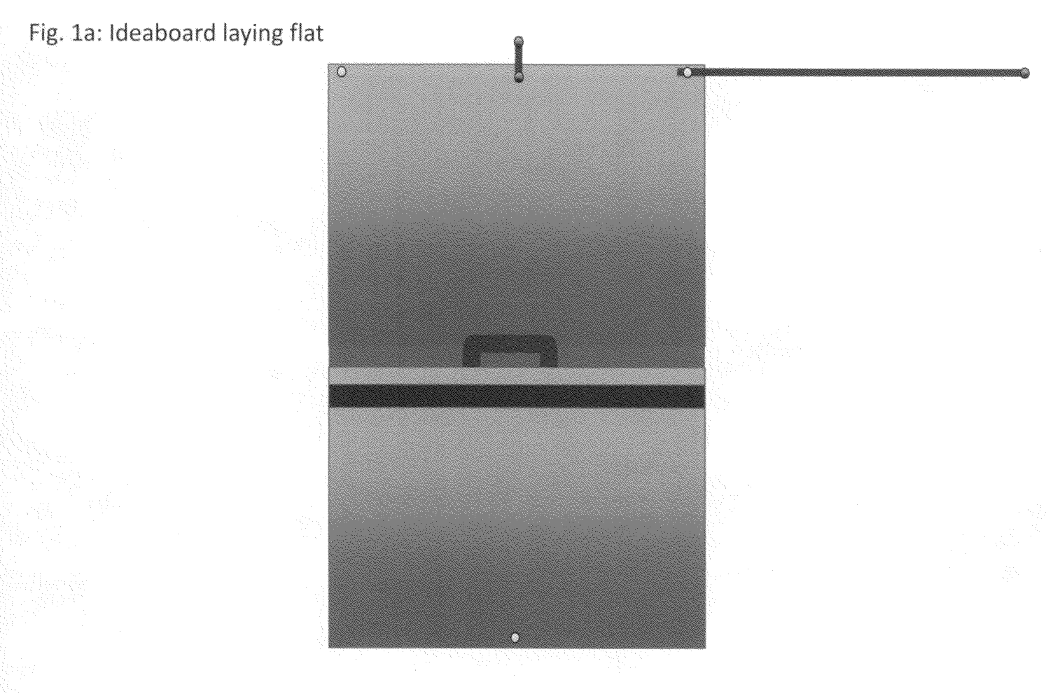

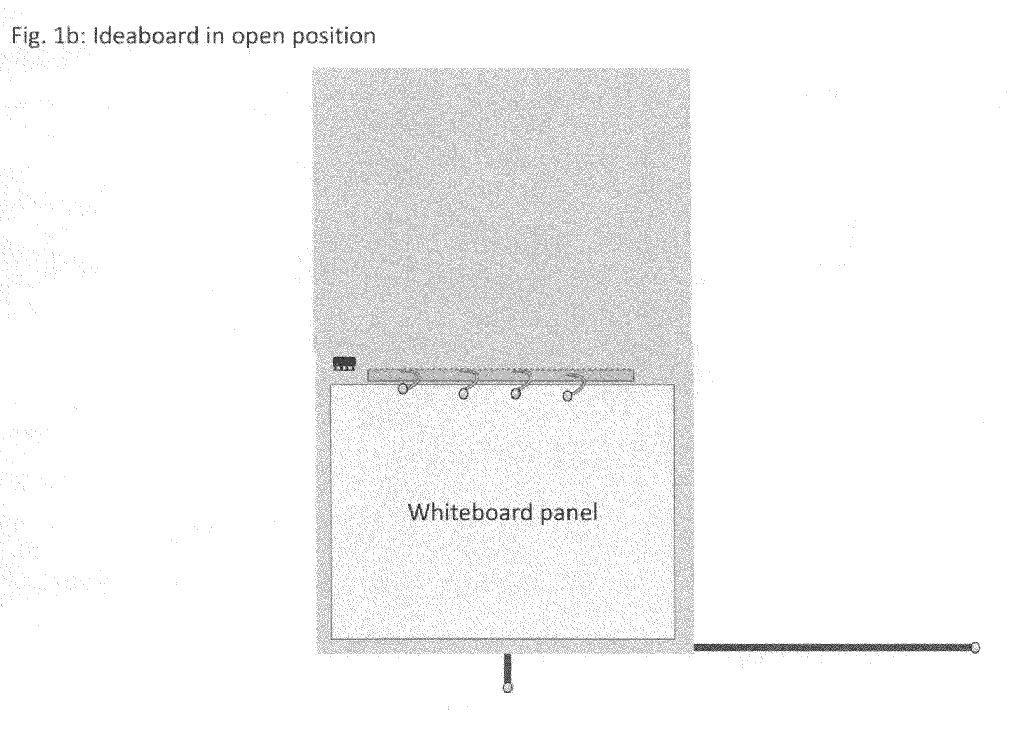

FIG. 1a. Laying flat

The Ideaboard shown lying flat (front outside) depicts metal snap buttons and the elastic strap originating from bottom right side of the back cover, as well as the small PU strap closure on the front center of Ideaboard.

FIG. 1b. Opened

The Ideaboard has been opened to show the inside area. This shows the 4 ring binder that holds the clear PVC Sheets, dry erase sheets and clear PVC template pockets that were designed especially for the Ideaboard. The black colored elastic marker holder holds a dry erase marker.

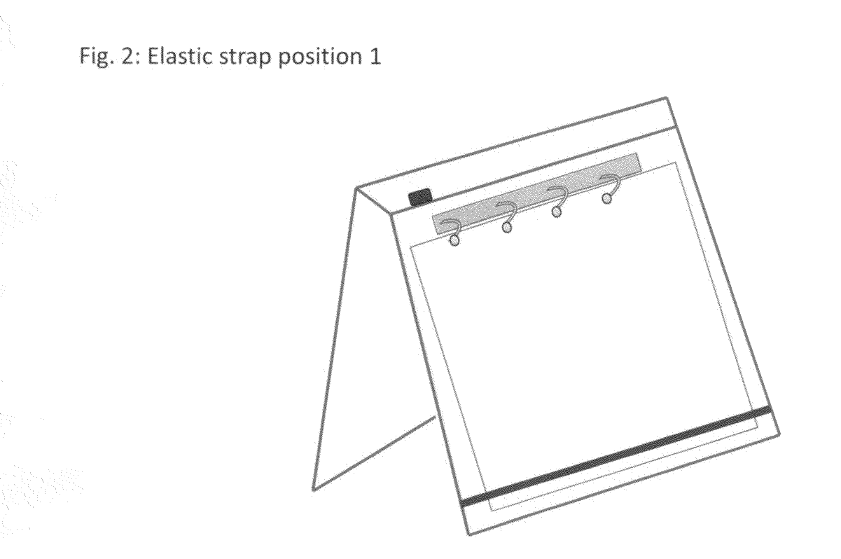

FIG. 2. Elastic Strap Position 1

The elastic strap has been designed for usage in 2 ways. This is the first position of the elastic strap, which originates from the bottom right area of the back cover of the Ideaboard. By stretching it over the sheets, and affixing it to the snap on the bottom back left, we use it to secure the Whiteboard and clear PVC sheets in place.

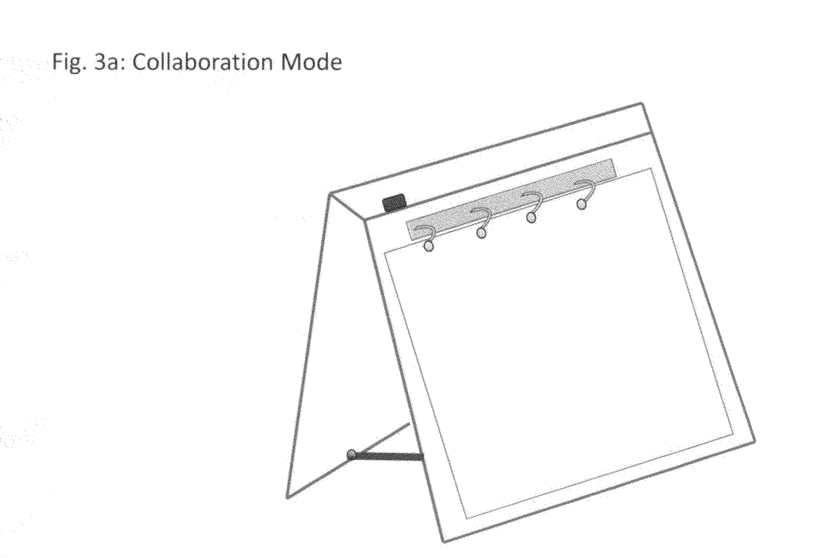

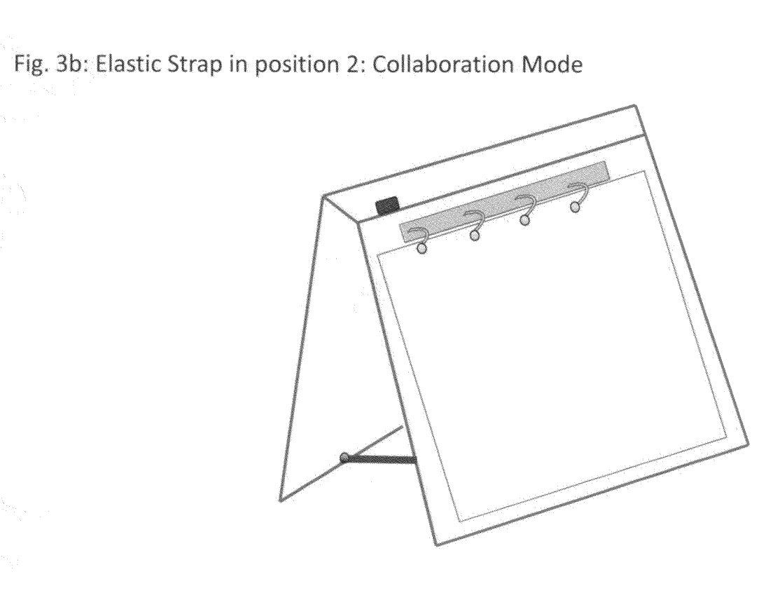

FIG. 3a. Collaboration Mode

This is the Ideaboard in “Collaboration Mode” which is done by affixing the same elastic strap that is permanently attached on the bottom right side back cover to the snap closure located on the front center of the board. By doing this we create a tent like shape of the Ideaboard called Collaboration Mode, which is now held sturdy by the strap when it is placed on a desk to allow for collaboration with colleagues.

FIG. 3b. Elastic strap in position 2

This is the second position of the elastic strap—which is to secure the Ideaboard while in “Collaboration Mode”. This keeps the Ideaboard sturdy and steady on a mostly flat surface such as a desk or floor.

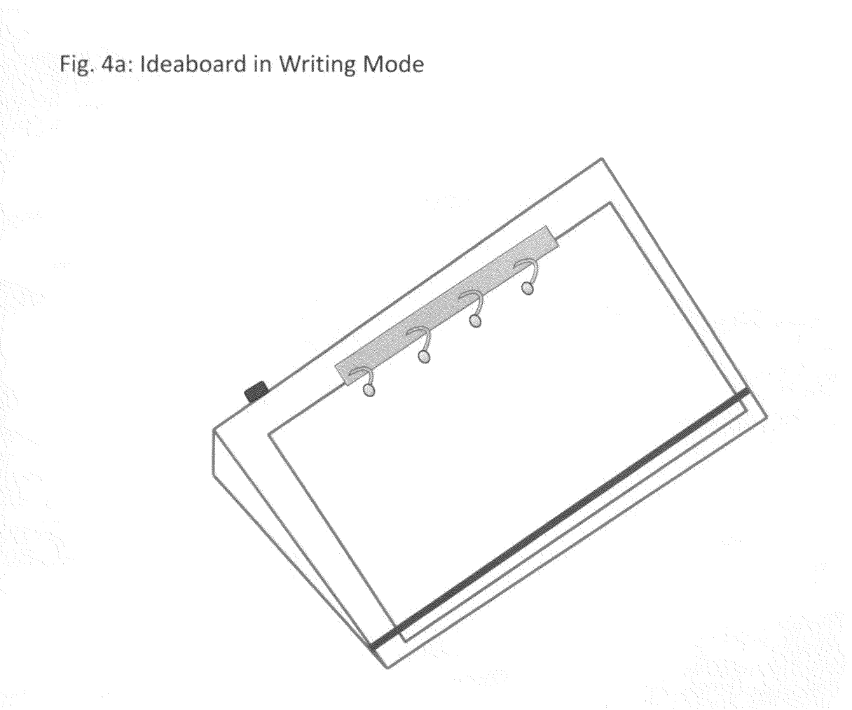

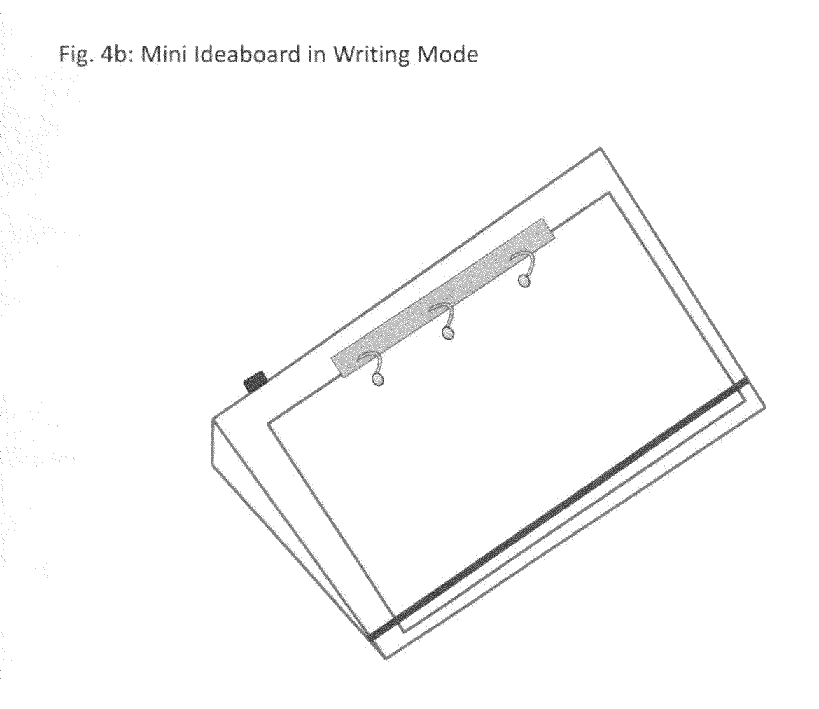

FIG. 4a. Ideaboard in Writing Mode

This is the Ideaboard in “Writing Mode.” Writing Mode occurs when the front cover is opened and is folded over the back cover all the way, so that the inside front cover actually rests against the desk surface creating an ergonomic writing angle for the user to work with. The elastic strap secures the whiteboard and clear sheets in place.

FIG. 4b. Mini Ideaboard Writing Mode

This is the Mini Ideaboard in “Writing Mode” The Mini Ideaboard is the exact same design as the Ideaboard, except it does not have a handle and it has 3 rings to hold the sheets instead of 4.

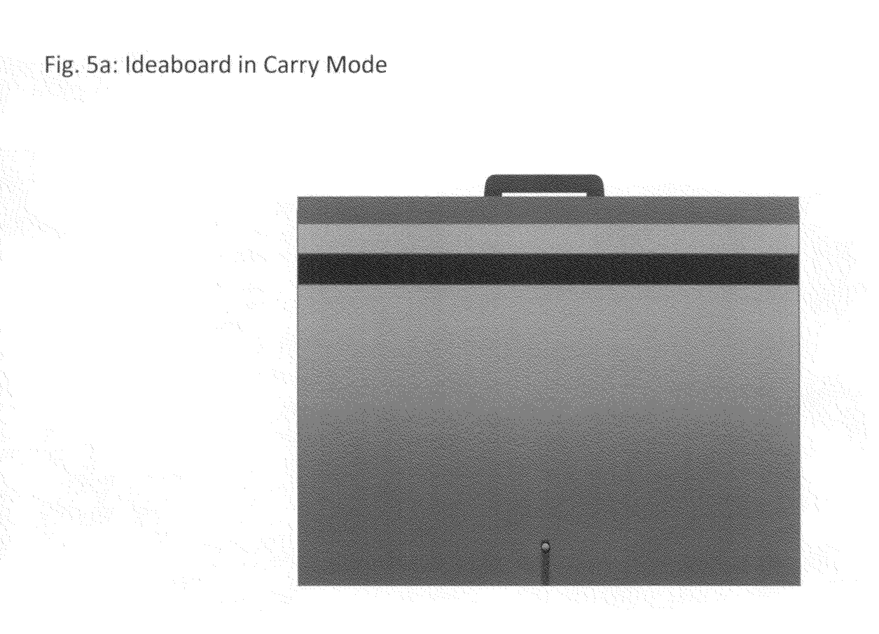

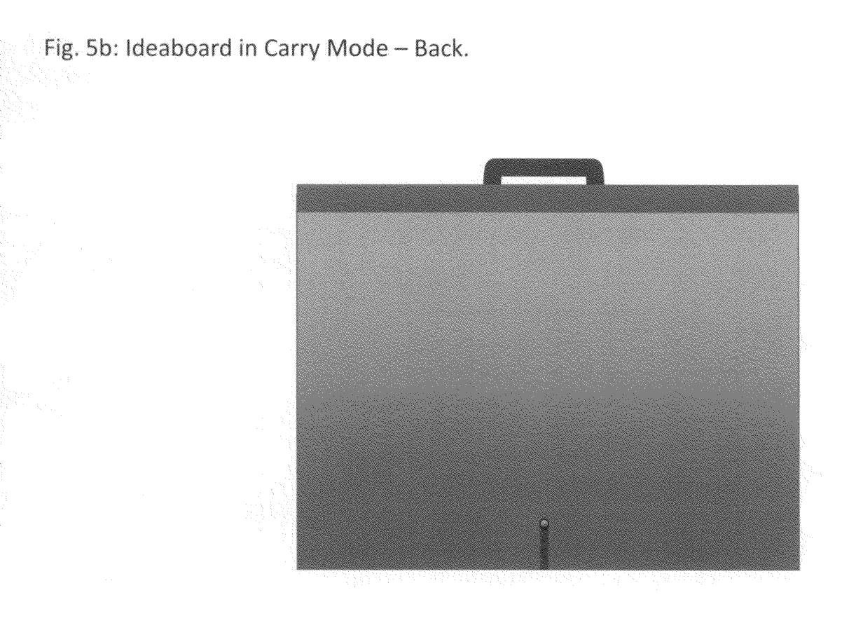

FIG. 5a. Ideaboard in Carry Mode

This is the Ideaboard in Closed position for carrying it around using the handle. This is the front side.

FIG. 5b. Ideaboard in Carry Mode—Back.

This is the Ideaboard in Closed position for carrying, back side.

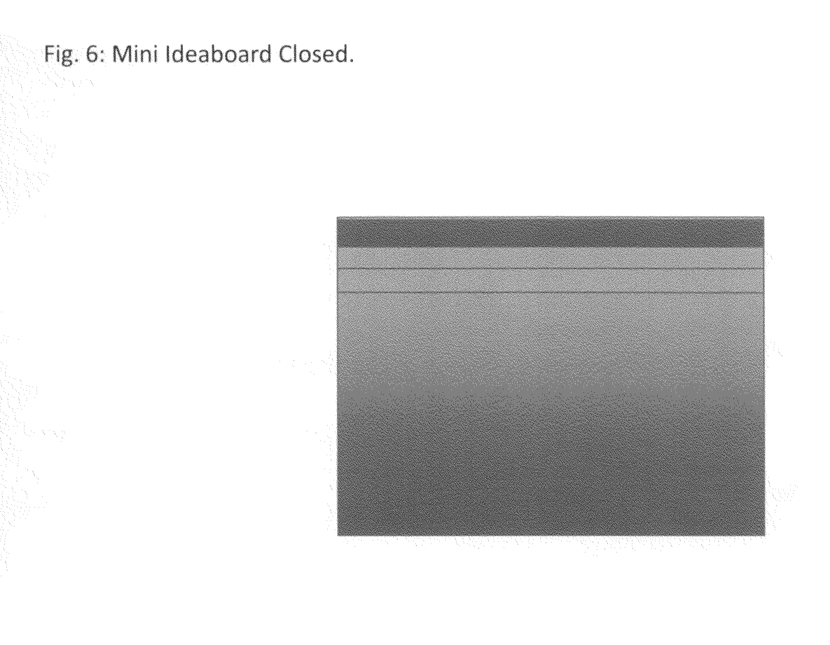

FIG. 6. Mini Ideaboard Closed

This is the Mini Ideaboard front, closed position. You carry it like you would carry a binder.

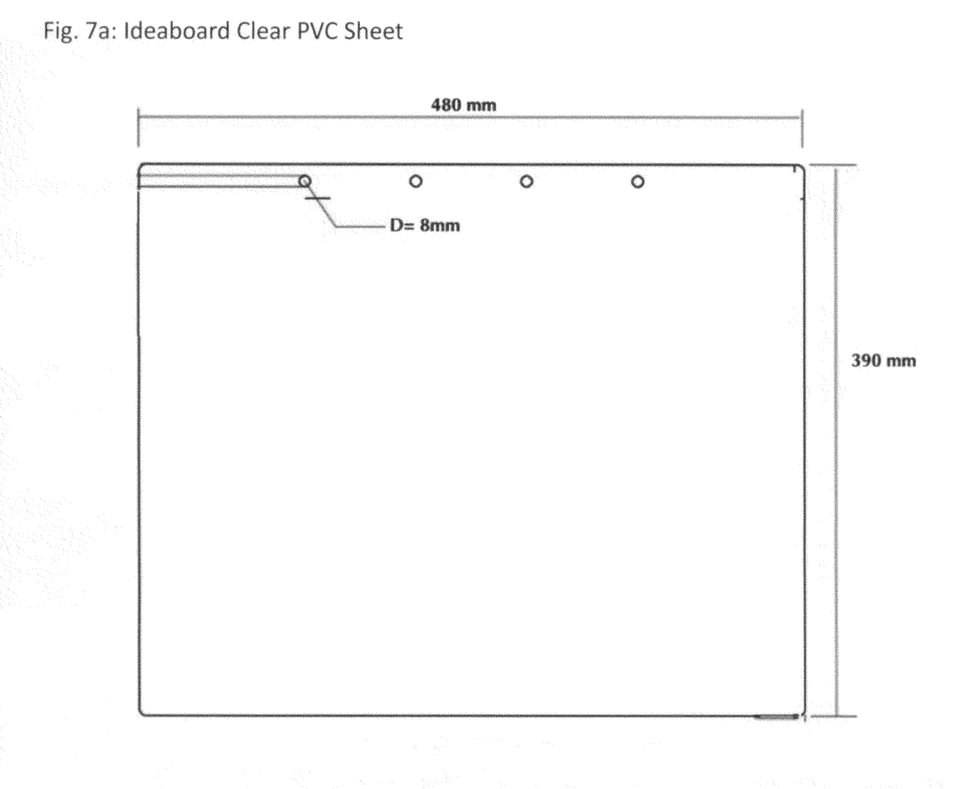

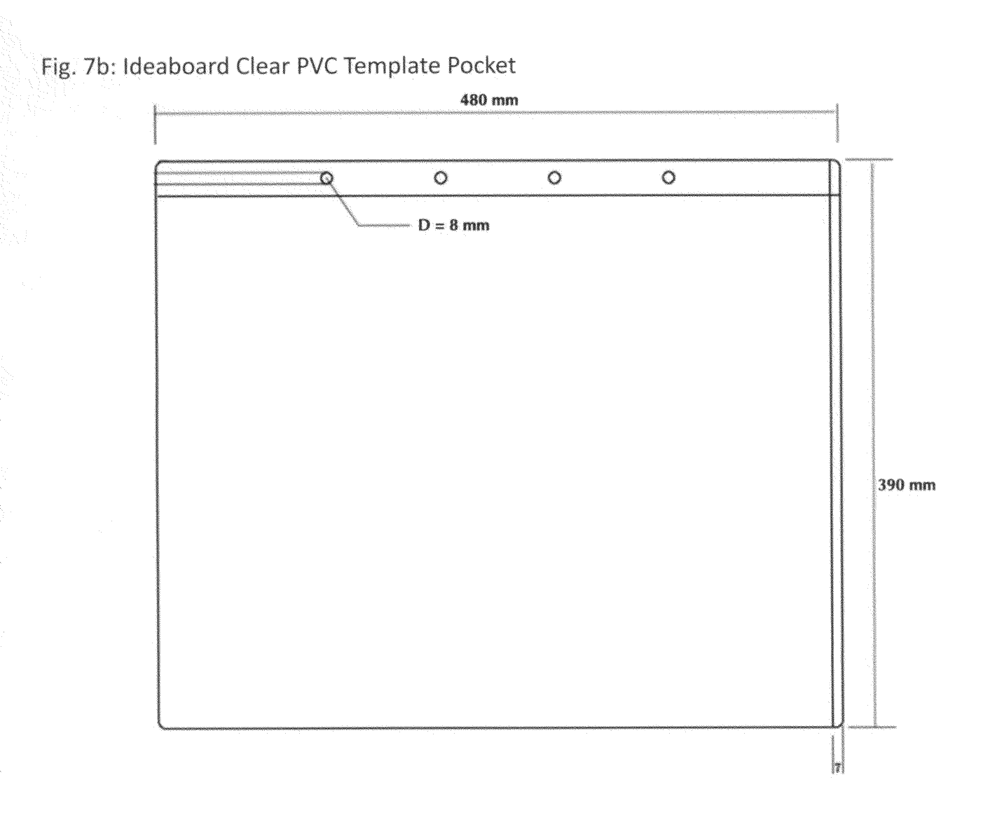

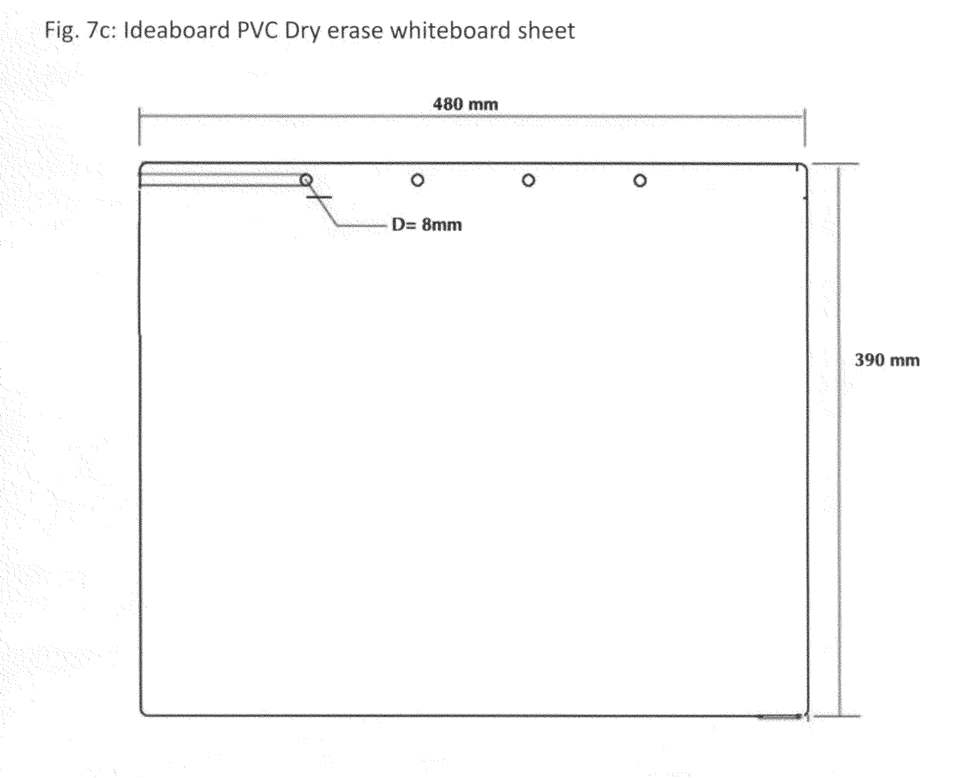

FIG. 7a. Ideaboard Clear PVC Sheet 0.2 mm Thick

Medium Ideaboard Clear PVC sheet with following dimensions:

Length of sheet: 480 mm

Height of sheet: 390 mm

Diameter of hole punch: 8 mm

Thickness of sheet: 0.2 mm

FIG. 7b. Ideaboard Clear PVC Template Pocket 0.5 mm Thick

Medium Ideaboard Clear PVC Template Pocket with following dimensions

Length of sheet: 480 mm

Height of sheet: 390 mm

Diameter of hole punch: 8 mm

Thickness of sheet: 0.5 mm

FIG. 7c. Ideaboard PVC Dry Erase Whiteboard Sheet 0.3 mm Thick

Medium Ideaboard Dry erase PVC whiteboard sheet with following dimensions:

Length of sheet: 480 mm

Height of sheet: 390 mm

Diameter of hole punch: 8 mm

Thickness of sheet: 0.3 mm

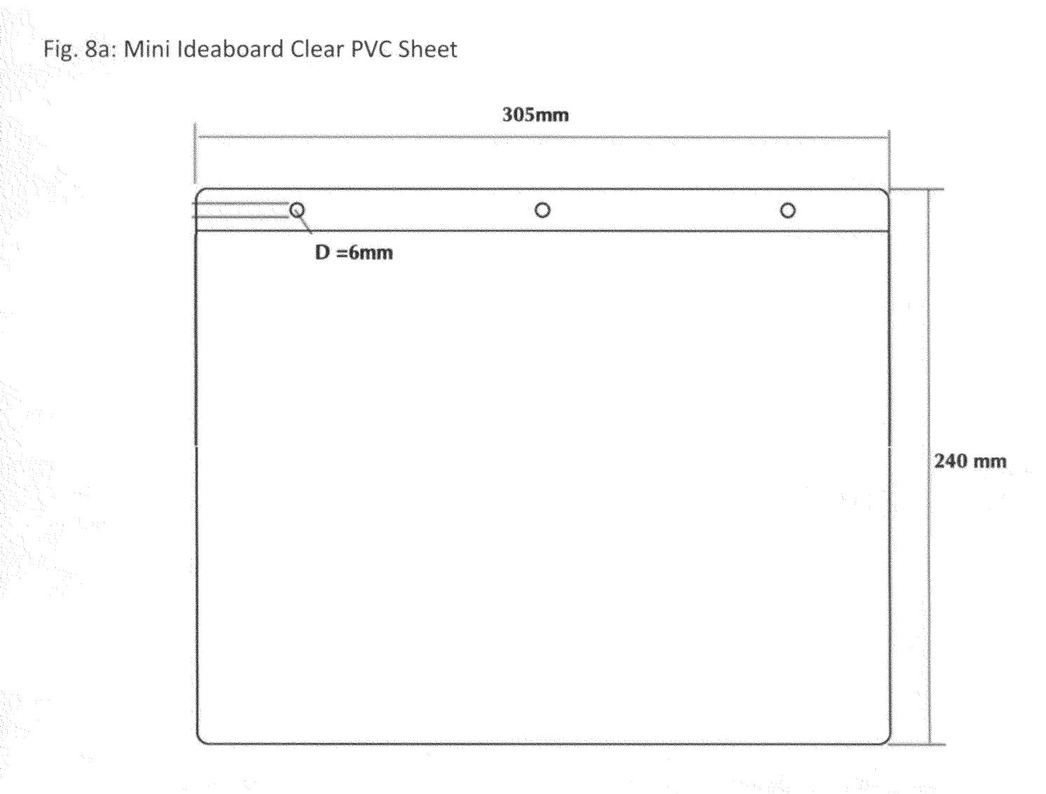

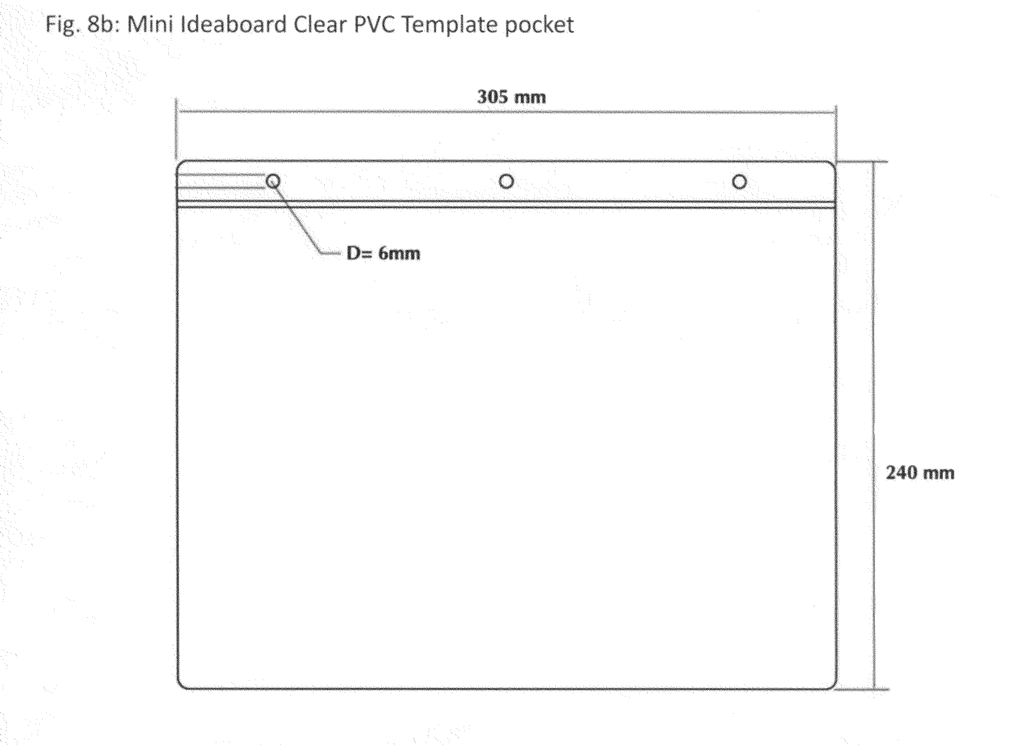

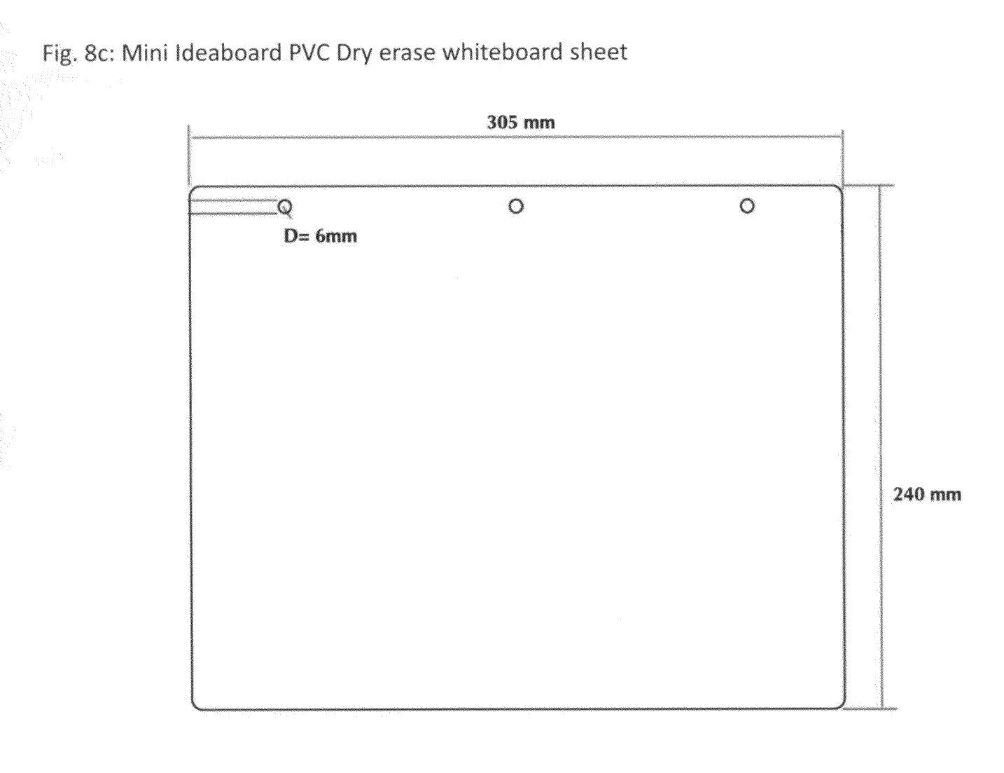

FIG. 8a. Mini Ideaboard Clear PVC sheet 0.2 mm Thick

Mini Ideaboard Clear PVC Sheet with following dimensions

Length of sheet: 305 mm

Height of sheet: 240 mm

Diameter of hole punch: 6 mm

Thickness of sheet: 0.2 mm

FIG. 8b. Mini Ideaboard Clear PVC Template Pocket 0.5 mm Thick

Mini Ideaboard Clear PVC Template Pocket with following dimensions:

Length of sheet: 305 mm

Height of sheet: 240 mm

Diameter of hole punch: 6 mm

Thickness of sheet: 0.5 mm

FIG. 8c. Mini Ideaboard PVC Dry Erase whiteboard sheet 0.3 mm Thick

Mini Ideaboard PVC dry erase whiteboard sheet with following dimensions:

Length of sheet: 305 mm

Height of sheet: 240 mm

Diameter of hole punch: 6 mm

Thickness of sheet: 0.3 mm

1. Design of having a ring binder to hold multiple dry erase sheets in a binder format.

2. Design use and placement of the elastic strap: to secure the sheets in place, to create collaboration mode and keep the board sturdy in collaboration mode.

3. Portability of Ideaboard—both the Medium size and Mini size and all of its Contents—multiple dry erase whiteboard sheets, clear dry erase PVC sheets and clear dry erase PVC template pockets.
Dependent on claim 1, 2, 3

4. According to claim 3, the dry erase whiteboard sheets are coated PVC sheets.

5. According to claim 3, the clear dry erase PVC Template pockets are used for editing printed templates placed within, since the surface property of the pocket is dry erase.

6. According to claim 3, the clear dry erase PVC sheets prevent excessive smudging from occurring when the whiteboard sheets rub against one another and allow the user to make secondary edits on top of the whiteboard sheets.
